(19) United States
(12) Patent Application Publication
(10) Pub. No.: US 2007/0261568 A1
(43) Pub. Date: Nov. 15, 2007

(54) Triangular frying pan

(76) Inventor: Milton Smothers, Blythe, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/431,320

(22) Filed: May 10, 2006

(51) Int. Cl. A47J 37/10

(52) U.S. Cl. 99/424

(57) ABSTRACT

A triangular frying pan includes a planar, triangular base. The base has a top surface to receive a food product, a bottom surface to rest upon a stove burner and first, second and third side edges. The sidewalls extend upwardly from first, second and third side edges, respectively. At least one pouring spout is formed at an intersection of any two of the first, second and third sidewalls. A handle has a gripping end and an attaching end and is attached to one of the first, second and third sidewalls. At least one of the sidewalls is attached to the base at an angle greater than 90 degrees. The handle is attached at an intersection of any two of the first, second and third sidewalls. The top and inner surfaces of the frying pan are coated with a non-stick material. A lid is sized and shaped to fit the pan.

### FIELD OF INVENTION

The invention pertains to cooking equipment. More particularly, the invention relates to a frying pan adapted for ease of use and safe removal of grease.

### BACKGROUND OF THE INVENTION

Frying pans have been used for hundreds of years for cooking a wide variety of foods. While extremely useful, these pans can be very dangerous. Frying pans are often used with a substantial quantity of grease, fat or broth or water (poaching and steaming) and the handling and disposal of these liquids, particularly when heated to high temperatures carries the risk of spillage and possible severe burns. Various design for frying pans have been developed by inventors that attempt to ameliorate the danger inherent in handling hot liquids in these pans.

U.S. Pat. No. 377,712, issued to Eymer, discloses a group of sector-shaped pots. When placed together with their radial walls in contact around a common angular center, they form a circle of pots or pans which may be located over a pot hole of a stove so that each of the sectional pots can receive a portion of the heat. Each pot has a handle extending from the upper portion of its circular wall. The handle is located at the midpoint of the sector circumferential arc.

U.S. Pat. No. 1,526,397, issued to Thornton is directed to sector-shaped cooking and serving containers constructed of metal, china, or other suitable materials. Each of the containers is adapted to contain a separate and individual portion of a confection, the individual containers being organized into a single main container to facilitate easy handling and cooking, but being free and separate to be removed from the main container so that the serving of one or more of the individual portions does not interfere with the remaining portions.

U.S. Pat. No. 6,287,619, issued to Khan illustrates a pan for baking e.g. single-serving-sized food product is adapted to promote substantially even heat distribution, to shield the food product from excessive browning and crisping, and to substantially prevent burning. The pan accomplishes these functions by utilizing one or more structural features, including, for example, perforations, sloped, variable-height walls and a sloped arcuate rim.

Embodiments of the invention may be used in combination with a separator to stack and store food product in a heated or cooled receptacle, and in combination with a slicing/topping guide.

U.S. Pat. No. 2,177,487, issued to Howlett disclose a double frying pan, each being generally oval in shape with a flattened side for positioning them together over a single burner. One pan is substantially deeper than the other so that when they are positioned together, the rim of the shallower pan is below the rim of the deeper one. The shallower pan may also be inverted upon the deeper one, their rims engaged within a groove, as shown in FIG. 3, thus creating a sealed cooking unit.

It is an objective of the present invention to provide a frying pan that is safe and convenient to use. It is a further objective to provide a pan that may be easily emptied of hot liquids without danger of spillage. It is a still further objective of the invention to provide a frying pan that can be easily emptied from either side as well as from a frontal spout. Finally, it is an objective of the present invention to provide such a pan that is both durable and easily and inexpensively manufactured.

While some of the objectives of the present invention are disclosed in the prior art, none of the inventions found include all of the requirements identified.

### SUMMARY OF THE INVENTION

The present invention addresses all of the deficiencies of prior art frying pan inventions and satisfies all of the objectives described above.

(1) A triangular frying pan, providing all of the desired features can be fabricated from the following components. A generally planar base is provided. The base is substantially triangular in shape, has a top surface to receive a food product, a bottom surface to rest upon a stove burner and first, second and third side edges. First, second and third sidewalls are provided. The sidewalls extend upwardly from the first, second and third side edges, respectively. At least one pouring spout is provided. The spout is formed at an intersection of any two of the first, second and third sidewalls. A handle is provided. The handle has a gripping end and an attaching end and is attached at the attaching end to one of the first, second and third sidewalls.

(2) In a variant of the invention, at least one of the sidewalls is attached to the base at an angle greater than 90 degrees.

(3) In another variant, a spout is formed at each intersection of any two of the first, second and third sidewalls.

(4) In still another variant, the handle is insulated to prevent conduction of heat from the frying pan.

(5) In yet a further variant, the spout is formed in an arcurate shape.

(6) In still a further variant, the handle is attached at an intersection of any two of the first, second and third sidewalls.

(7) In another variant of the invention, the top surface of the base and inner surfaces of the first, second and third sidewalls are coated with a non-stick material.

(8) In a final variant, a lid is provided. The lid is sized and shaped to fit within the first, second and third sidewalls and has an opening to permit pouring liquid from the spout.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention;

FIG. 2 is a top plan view of the FIG. 1 embodiment;

FIG. 3 is a perspective view of a second embodiment with angled side walls;

FIG. 4 is a perspective view of the FIG. 1 embodiment with corner pouring spouts;

FIG. 5 is a perspective view of the FIG. 1 embodiment with an insulated handle;

FIG. 6 is a perspective view of the FIG. 1 embodiment with an arcurate pouring spout;

FIG. 7 is a perspective view of a third embodiment with the handle attached at an intersection of the side walls;

FIG. 8 is a perspective view of the FIG. 1 embodiment with a non-stick interior; and

FIG. 9 is a perspective view of the FIG. 1 embodiment with a lid to allow draining of the pan.

### DETAILED DESCRIPTION OF THE PREFERRED EMBODIMENT

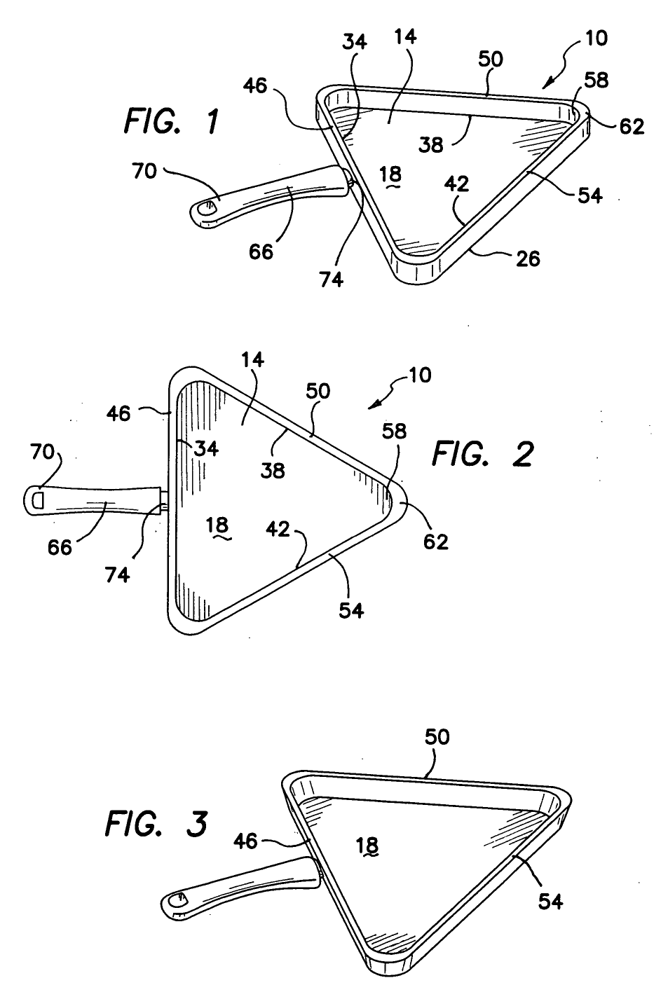

(1) FIGS. 1-9 illustrate a triangular frying pan 10, providing all of the desired features can be fabricated from the following components. A generally planar base 14 is provided. The base 14 is substantially triangular in shape, has a top surface 18 to receive a food product (not shown), a bottom surface 26 to rest upon a stove burner (not shown) and first 34, second 38 and third 42 side edges. First 46, second 50 and third 54 sidewalls are provided. The sidewalls 46, 50, 54 extend upwardly from the first 34, second 38 and third 42 side edges, respectively. At least one pouring spout 58 is provided. The spout 58 is formed at an intersection 62 of any two of the first 46, second 50 and third 54 sidewalls. A handle 66 is provided. The handle 66 has a gripping end 70 and an attaching end 74 and is attached at the attaching end 74 to one of the first 46, second 50 and third 54 sidewalls.

(2) In a variant of the invention, as illustrated in FIG. 3, at least one of the sidewalls 46, 50, 54 is attached to the base 14 at an angle greater than 90 degrees.

(3) In another variant, as illustrated in FIG. 4, a spout 58 is formed at each intersection 62 of any two of the first 46, second 50 and third 54 sidewalls.

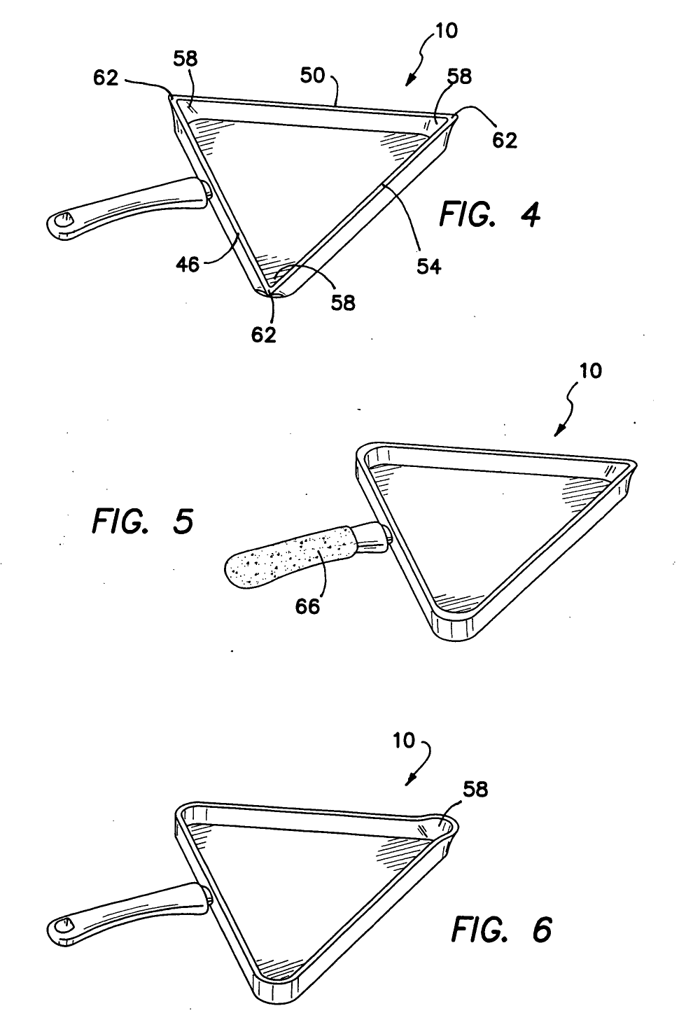

(4) In still another variant, as illustrated in FIG. 5, the handle 66 is insulated to prevent conduction of heat from the frying pan 10.

(5) In yet a further variant, as illustrated in FIG. 6, the spout 58 is formed in an arcurate shape.

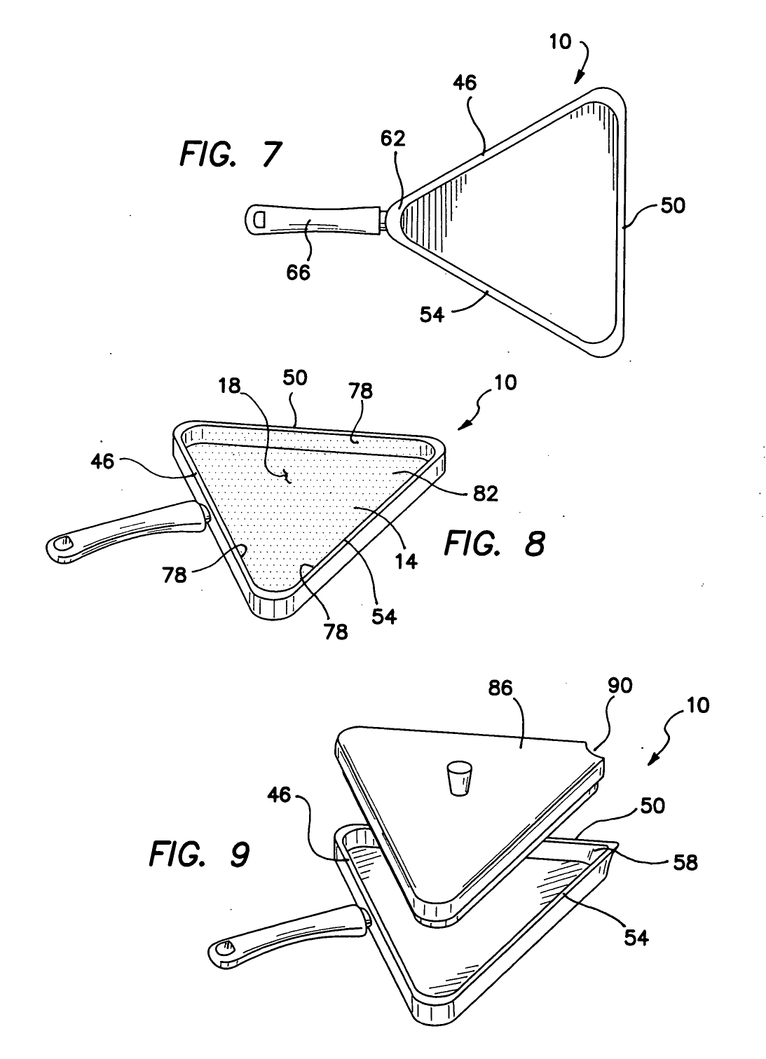

(6) In still a further variant, as illustrated in FIG. 7, the handle 66 is attached at an intersection 62 of any two of the first 46, second 50 and third 54 sidewalls.

(7) In another variant of the invention, as illustrated in FIG. 8, the top surface 18 of the base 14 and inner surfaces 78 of the first 46, second 50 and third 54 sidewalls are coated with a non-stick material 82.

(8) In a final variant, as illustrated in FIG. 9, a lid 86 is provided. The lid 86 is sized and shaped to fit within the first 46, second 50 and third 54 sidewalls and has an opening 90 to permit pouring liquid (not shown) from the spout 58.

The triangular frying pan 10 has been described with reference to particular embodiments. Other modifications and enhancements can be made without departing from the spirit and scope of the claims that follow.

1. A triangular frying pan, comprising:
a generally planar base, said base being triangular in shape, having a top surface to receive a food product, a bottom surface to rest upon a stove burner and first, second and third side edges;
first, second and third sidewalls, said sidewalls extending upwardly from said first, second and third side edges, respectively;
at least one pouring spout, said spout being formed at each intersection of any two of said first, second and third sidewalls; and
a handle, said handle having a gripping end and an attachment end and attached at said attachment end to one of said first, second and third sidewalls.

2. The triangular frying pan, as described in claim 1, wherein at least one of said sidewalls is attached to said base at an angle greater than 90 degrees.

3. (canceled)

4. The triangular frying pan, as described in claim 1, wherein said handle is insulated to prevent conduction of heat from said frying pan.

5. The triangular frying pan, as described in claim 1, wherein said spout is formed in an arcurate shape.

6. (canceled)

7. The triangular frying pan, as described in claim 1, wherein said top surface of said base and inner surfaces of said first, second and third sidewalls are coated with a non-stick material.

8. The triangular frying pan, as described in claim 1, further comprising a lid, said lid being sized and shaped to fit within said first, second and third sidewalls and having an opening to permit pouring liquid from said spout.
